(19) United States
(12) Patent Application Publication
(10) Pub. No.: US 2026/0110610 A1
(43) Pub. Date: Apr. 23, 2026

(54) PULL-TEST JIG FOR MICROCHIPS AND TEST APPARATUS AND METHOD USING THE SAME

(71) Applicant: KOREA ELECTRONICS TECHNOLOGY INSTITUTE, Seongnam-si (KR)

(72) Inventors: Min Hyung KANG, Jeonju-si (KR); Jin Bee PARK, Jeonju-si (KR); Young Kyu HONG, Daejeon (KR)

(21) Appl. No.: 19/365,642

(22) Filed: Oct. 22, 2025

(30) Foreign Application Priority Data
Oct. 23, 2024 (KR) 10-2024-0145845

(51) Int. Cl. G01N 3/08; G01N 3/02

(52) U.S. Cl. CPC G01N 3/08; G01N 3/02; G01N 2203/0017; G01N 2203/0405; G01N 2203/0429

(57) ABSTRACT

A pull-test jig for microchips and a test apparatus and method using the same are disclosed. The microchip pull-test jig comprises a sample fixer provided, at an upper surface thereof, with a sample seat configured to fix a substrate to which a microchip is connected by a solder, a stud support disposed over the sample fixer and formed with a stud hole at a position corresponding to the microchip, a stud fixed to an upper surface of the microchip through the stud hole, and a stud holder separably coupled to the stud.

### CROSS REFERENCE TO RELATED APPLICATION

The present application claims priority to Korean Patent Application No. 10-2024-0145845, filed Oct. 23, 2024, the entire contents of which is incorporated herein for all purposes by this reference.

### TECHNICAL FIELD

The present disclosure relates to a pull-test jig for microchips and a test apparatus and method using the same.

### BACKGROUND

A semiconductor chip may be connected to a substrate using a solder. A pull-test method may be used to evaluate the tensile strength of solder joints that connect the semiconductor chip to the substrate. The pull test is a destructive analysis method in which the semiconductor chip connected to the substrate is pulled. The pull test may be performed by attaching a stud to the semiconductor chip, fixing the substrate in a sample fixer, inserting the stud into a stud holder, and pulling the stud holder using a tensile strength tester.

Meanwhile, the size of semiconductor chips has been gradually reduced in accordance with technological advancement. Application of general pull-test jigs for semiconductor chips to microchips may be difficult. Therefore, a jig capable of performing a pull test for semiconductor chips having a small size is needed.

### SUMMARY

An aspect of the present disclosure is to provide a pull-test jig comprising a stud support configured to accurately attach a stud to a microchip, and a test apparatus and method using the same.

In accordance with an aspect of the present disclosure, a microchip pull-test jig comprises a sample fixer provided, at an upper surface thereof, with a sample seat configured to fix a substrate to which a microchip is connected by a solder, a stud support disposed over the sample fixer and formed with a stud hole at a position corresponding to the microchip, a stud fixed to an upper surface of the microchip through the stud hole, and a stud holder separably coupled to the stud.

In accordance with an embodiment, the sample fixer may further comprise a guide pin protruding upwards from the upper surface of the sample fixer at an edge of the sample fixer around the sample seat, and the stud support may be formed with a pin hole at a position corresponding to the guide pin, allowing insertion of the guide pin into the pin hole.

In accordance with an embodiment, the microchip pull-text jig may further comprise an adhesive configured to bond the stud to the microchip.

In accordance with an embodiment, the stud may comprise a body formed to have a first width, and an end portion formed to have a second width smaller than the first width. The end portion may protrude from a lower portion of the body such that the end portion is fixed to the upper surface of the microchip.

In accordance with an embodiment, the stud hole may comprise a body space extending from an upper surface of the stud fixer toward a lower surface of the stud fixer and having the first width, and an end space formed at a lower surface of the stud support such that the end space is contiguous with a lower portion of the body space and has the second width.

In accordance with an embodiment, the end space may be formed to have a diameter larger than a size of the microchip such that the microchip is insertable into the end space.

In accordance with an embodiment, the microchip pull-text jig may further comprise at least one distance adjustment ring inserted into the body space to adjust an insertion distance of the stud. The distance adjustment ring may be formed to have an outer diameter corresponding to the first width and formed with a hole having the second width at a central portion thereof.

In an aspect of the present disclosure, a test apparatus using a microchip pull-text jig comprises the microchip pull-text jig as described above, a tensile strength tester configured to measure tensile strength by pulling the stud holder, and a controller configured to receive data of the tensile strength measured by the tensile strength tester and to display the measured tensile strength.

In an aspect of the present disclosure, a test method using a microchip pull-test jig comprises sample fixing of fixing a substrate, to which a microchip is connected by a solder, to a sample fixer, support connection of connecting a stud support to an upper portion of the sample fixer, chip fixing of inserting a stud into a stud hole of the stud support, and fixing the stud to an upper surface of the microchip, stud holding of coupling a first coupling portion of the stud to a second coupling portion of a stud holder, and measurement of performing tensile strength measurement by controlling, by a controller, a tensile strength tester to pull the stud holder.

In accordance with an embodiment, in the holder connection, a guide pin formed at an edge of the sample fixer to protrude upwards may be inserted into a pin hole formed at the stud support.

In accordance with an embodiment, in the holder connection, the microchip may be inserted into a lower portion of a guide hole formed at the stud support.

In accordance with an embodiment, the stud may comprise a body formed to have a first width, and an end portion formed to have a second width smaller than the first width, the end portion protruding from a lower portion of the body such that the end portion is fixed to an upper surface of the microchip. The stud hole may comprise a body space extending from an upper surface of the stud support toward a lower surface of the stud support and having the first width, and an end space formed at the lower surface of the stud support such that the end space is contiguous with a lower portion of the body space and has the second width. In the chip fixing, a lower surface of the body of the stud may be supported by a lower surface of the body space such that a predetermined gap is maintained between the upper surface of the microchip and a lower surface of the end portion, and the lower surface of the end portion and the upper surface of the microchip may be fixed to each other by an adhesive.

In accordance with an embodiment the test method may further comprise insertion distance adjustment of inserting, into the body space, at least one distance adjustment ring formed to have an outer diameter of a first width and formed with a hole having a second width at a central portion thereof, before the chip fixing, to adjust an insertion distance of the stud.

In accordance with an embodiment, the measurement may comprise controlling, by the controller, the tensile strength tester to pull the stud holder, pulling, by the tensile strength tester, the stud holder to measure tensile strength and transmitting results of the measurement from the tensile strength tester to the controller, and stopping the tensile strength measurement when any one of the microchip, the solder, and the substrate breaks.

Prior to the description, it should be understood that the terms used in the specification and appended claims should not be construed as limited to general and dictionary meanings, but interpreted based on the meanings and concepts corresponding to technical aspects of the present disclosure on the basis of the principle that the inventor is allowed to define terms appropriately for best explanation.

In accordance with an embodiment of the present disclosure, it may be possible to securely fix the stud to a semiconductor microchip at a correct position.

In accordance with an embodiment of the present disclosure, it may be possible to prevent bonding failure between the semiconductor microchip and the stud.

In accordance with an embodiment of the present disclosure, it may be possible to reliably perform a pull test of the semiconductor microchip.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a view showing a test apparatus using a microchip pull-test jig according to an embodiment;

FIG. 2 is a view showing failure occurring when a large stud is fixed to a microchip;

FIG. 3 is a view showing each constituent element of the microchip pull-test jig according to the embodiment;

FIG. 4 is a view showing a connected state of the microchip pull-test jig according to the embodiment;

FIG. 5 is a view showing the microchip pull-test jig which uses a distance adjustment ring in accordance with an embodiment;

FIG. 6 is a flowchart showing each step of a test method using the microchip pull-test jig in accordance with an embodiment; and

FIG. 7 is a diagram illustrating breakage of a microchip, a solder, or a substrate according to an embodiment.

### DETAILED DESCRIPTION

Hereinafter, with reference to the attached drawings, the present disclosure will be described in detail. However, this is only illustrative and the present disclosure is not limited to specific embodiments illustratively described.

Hereinafter, an embodiment of the present disclosure will be described in detail with reference to the accompanying drawings.

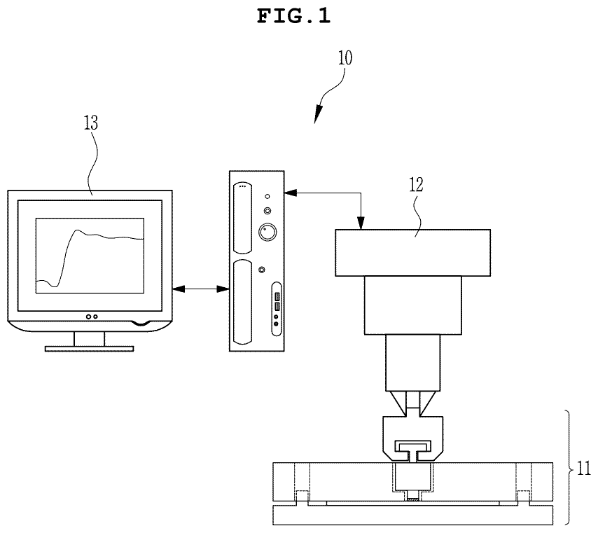

FIG. 1 is a view showing a test apparatus 10 using a microchip pull-test jig according to an embodiment.

In accordance with an embodiment, the test apparatus 10 may comprise a microchip pull-test jig 11, a tensile strength tester 12 configured to measure tensile strength by pulling a stud holder 140, and a controller 13 configured to receive data of the tensile strength measured by the tensile strength tester 12 and to display the measured tensile strength.

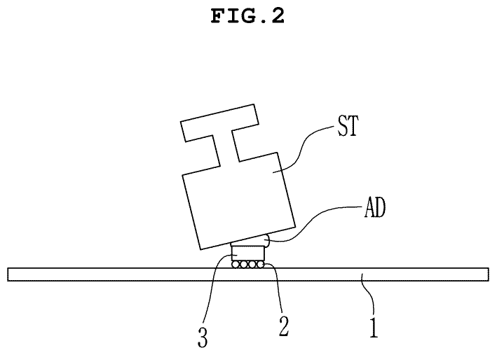

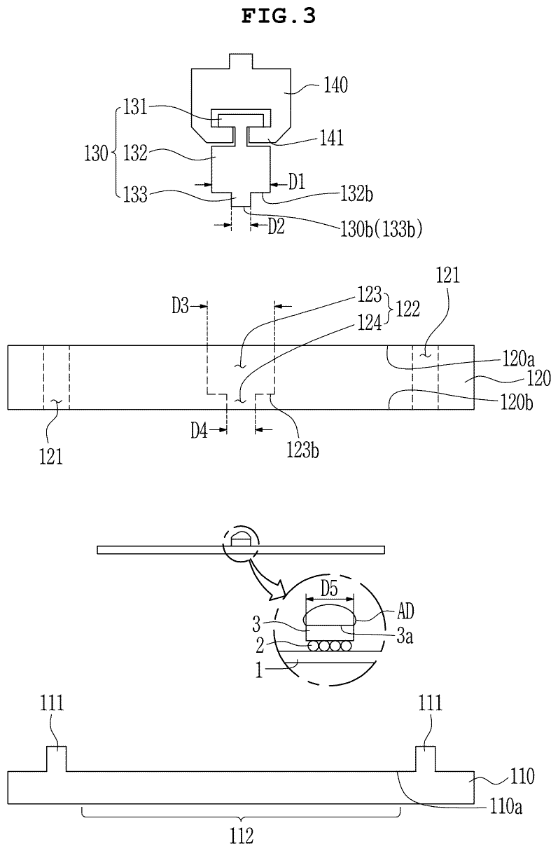

In accordance with an embodiment, the microchip pull-test jig 11 is a jig configured to apply a pull test to a semiconductor chip having a very small size, that is, a microchip. The microchip, which is designated by reference numeral “3” in FIG. 2, has a smaller size than a general stud 130 (FIG. 3). Using the microchip pull-test jig 11, the stud 130 may be fixed to a semiconductor chip at an accurate position even when the chip has a very small size. Using the microchip pull-test jig 11, pull testing of very small semiconductor chips may be reliably performed.

The tensile strength tester 12 may measure the tensile strength of a solder 2 connecting the microchip 3 to a substrate 1 by pulling the stud holder 140 of the microchip pull-test jig 11. The tensile strength tester 12 may measure in real time force pulling the stud holder 140 and may provide results of the measurement to the controller 13. The tensile strength tester 12 may perform an operation of pulling the stud holder 140 under control of the controller 13.

The controller 13 may control the tensile strength tester 12, may receive data obtained by the tensile strength tester 12 through measurement of tensile strength, and may display the measured tensile strength. The controller 13 may be a computer device configured to receive and display the data obtained by the tensile strength tester 12. The controller 13 may comprise a data acquisition and storage system and a monitor configured to display measured values. The tensile strength tester 12 and the controller 13 may be integrated into single tensile strength testing equipment.

FIG. 2 is a view showing failure occurring when a large stud 130 is fixed to the microchip 3.

Generally, a stud 130 having a smaller size than the area of a semiconductor chip is used in a pull test. The microchip 3 means a chip whose size is so small that attachment of a general stud 130 to the chip is difficult.

For example, a typical semiconductor chip has a size of 10×10 mm² or more, making it easy to attach a stud 130 having a smaller size than the semiconductor chip. However, when the size of the semiconductor chip is reduced below 2×2 mm², the area of the stud 130 may become larger than that of the semiconductor chip.

Although the stud 130 may be manufactured to be smaller than 2×2 mm², the small-sized stud 130 may be difficult to attach to a correct position when bonded to the semiconductor chip using an epoxy adhesive AD or the like. Additionally, during the process of holding the small stud 130 by the stud holder 140, failure may occur.

When a stud 130 having a larger size than the semiconductor chip is used, as shown in FIG. 2, the stud 130 is placed on the small semiconductor chip. As a result, failure may occur during a process of curing the epoxy adhesive AD. For example, the epoxy adhesive AD may be cured in a tilted state of the stud 130. For this reason, it is difficult to use the general pull-test jig for the microchip 3.

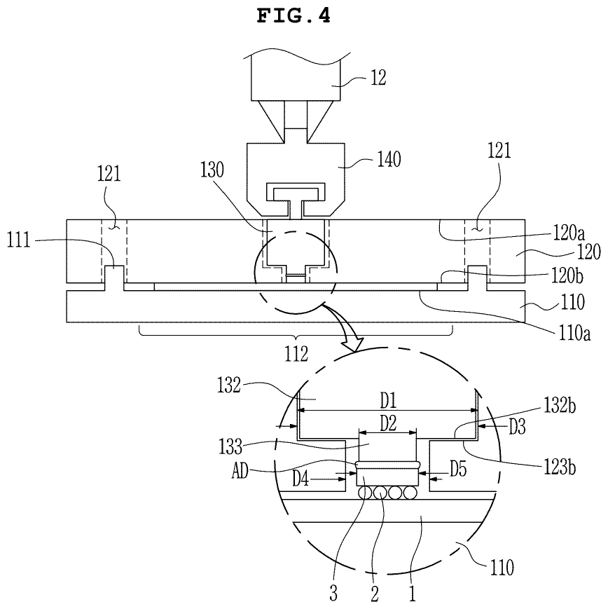

FIG. 3 is a view showing each constituent element of the microchip pull-test jig 11 according to the embodiment. FIG. 4 is a view showing a connected state of the microchip pull-test jig 11 according to the embodiment.

The microchip pull-test jig 11 may comprise a sample fixer 110 provided, at an upper surface 110a thereof, with a sample seat 112 configured to fix the substrate 1 to which the microchip 3 is connected by the solder 2, a stud support 120 disposed over the sample fixer 110 and formed with a stud hole 122 at a position corresponding to the microchip 3, a stud 130 fixed to an upper surface 3a of the microchip 3 through the stud hole 122, and the stud holder 140 separably coupled to the stud 130.

The sample fixer 110 is a plate configured to fix the sample. The sample may be the substrate 1 to which an object to be subjected to a pull test, that is, the microchip 3, is connected by the solder 2. The sample fixer 110 may be formed, at a central portion thereof, with the sample seat 112 to which the substrate 1 is fixed. The substrate 1 may be fixed to the sample seat 112 by various methods. For example, the sample seat 112 may fix the substrate 1 using a clip (not shown) or the like. The sample fixer 110 may maintain the substrate 1 in a fixed state when the microchip 3 is pulled by the stud 130, enabling measurement of tensile strength.

The stud support 120 may be connected to an upper portion of the sample fixer 110. The stud support 120 may be formed with the stud hole 122 configured to receive the stud 130. The stud hole 122 is a hole extending from an upper surface 120a to a lower surface 120b of the stud support 120. The stud hole 122 is a space into which the stud 130 is inserted. The stud hole 122 may guide the stud 130 to prevent tilting or deviation of the stud 130 from a predetermined position. The stud hole 122 may be formed at a central portion of the stud support 120.

The stud 130 may be fixed to the upper surface 3a of the microchip 3. A lower surface 130b of the stud 130 and the upper surface 3a of the microchip 3 may be fixed to each other. The stud 130 and the microchip 3 may be fixed using the adhesive AD. The stud 130 may be guided by the stud hole 122 to be fixed to the upper surface 3a of the microchip 3 without being tilted. A first coupling portion 131 may be formed at an upper portion of the stud 130.

The stud holder 140 may hold the first coupling portion 131 of the stud 130. The stud holder 140 may be formed, at a lower portion thereof, with a second coupling portion 141 corresponding to the first coupling portion 131 of the stud 130. A tensile strength tester 12 may be connected to an upper portion of the stud holder 140. When the tensile strength tester 12 pulls the stud holder 140, the stud holder 140 may pull the stud 130 held by the first coupling portion 131 and the second coupling portion 141. The stud 130 may pull the fixed microchip 3. Since the substrate 1 is fixed, the tensile strength of the solder 2 interconnecting the substrate 1 and the microchip 3 may be measured.

The sample fixer 110 may further comprise a guide pin 111 protruding upwards from an upper surface 110a of the sample fixer 110 at an edge of the sample fixer 110 around the sample seat 112. The stud support 120 may be formed with a pin hole 121 at a position corresponding to the guide pin 111, allowing insertion of the guide pin 111 into the pin hole 121.

The guide pin 111 and the pin hole 121 may be used to ensure that the sample fixer 110 and the stud support 120 are coupled to each other at a predetermined position.

The guide pin 111 may be formed at the edge of the sample fixer 110. The guide pin 111 may be formed outside the sample seat 112 of the sample fixer 110. The guide pin 111 may be formed in plural. The guide pin 111 may be formed to have a shape protruding upwards from the upper surface 110a of the sample fixer 110.

The pin hole 121 may be formed at an edge of the stud support 120. The pin hole 121 may be a space extending from the lower surface 120b of the stud support 120 toward the upper surface 120a of the stud support 120. The pin hole 121 may be a through hole extending through the upper and lower surfaces 120a and 120b of the stud support 120 or a groove formed at the lower surface 120b to be concave toward the upper surface 120a. The pin hole 121 may be formed at a position corresponding to the position of the guide pin 111. The guide pin 111 and the pin hole 121 may be formed to have sliding or fitting structures, respectively.

The microchip pull-test jig 11 may further comprise the adhesive AD configured to bond the stud 130 to the microchip 3. The adhesive AD may comprise an epoxy resin adhesive, a photocuring adhesive, a thermosetting adhesive, a two-part adhesive, or the like. The adhesive AD is applied to the upper surface 3a of the microchip 3, and is subsequently cured in a state in which the stud 130 contacts the upper surface 3a of the microchip 3, to fix the stud 130 and the microchip 3 to each other.

The stud 130 may comprise a body 132 formed to have a first width D1, and an end portion 133 formed to have a second width D2 smaller than the first width D1. The end portion 133 protrudes from a lower portion of the body 132 such that the end portion 133 is fixed to the upper surface 3a of the microchip 3. The stud 130 may further comprise the first coupling portion 131 which is formed at an upper portion of the body 132 and is separably coupled to the stud holder 140.

The body 132 is a thickened portion of the stud 130. The body 132 may be formed to have the first width D1. The body 132 may be formed to have a cylindrical shape, a hexahedral shape, or the like. The body 132 may be formed with the first coupling portion 131 at the upper portion thereof and may be formed with the end portion 133 at the lower portion thereof.

The end portion 133 may be formed to have the second width D2. The second width D2 may be smaller than the first width D1. The second width D2 may be smaller than the size of the microchip 3, D5. Alternatively, the second width D2 may be similar to or larger than the size D5 of the microchip 3. A lower surface 133b of the end portion 133 may be fixed to the upper surface 3a of the microchip 3 by the adhesive AD.

The first coupling portion 131 may be formed at the upper portion of the body 132. The first coupling portion 131 may be formed to have a T-shape, a ring shape, or various other shapes. The first coupling portion 131 may be formed to have a structure sufficiently robust to prevent deformation when pulled while connected to the second coupling portion 141.

The stud hole 122 may comprise a body space 123 extending from the upper surface 120a toward the lower surface 120b and having the first width D1, and an end space 124 formed at the lower surface 120b of the stud support 120 such that the end space 124 is contiguous with a lower portion of the body space 123 and has the second width D2.

The stud hole 122 may be a through hole extending through the upper surface 120a and the lower surface 120b of the stud support 120. The body space 123 is a portion of the stud hole 122. The body space 123 may be formed to have a shape corresponding to the body 132 of the stud 130. The body space 123 may be formed to have a third width D3. The third width D3 may be equal to or slightly larger than the first width D1. The body space 123 may accommodate the body 132 of the stud 130 when the stud 130 is inserted into the stud hole 122. The body space 123 may be a space extending from the upper surface 120a of the stud support 120 toward the lower surface 120b of the stud support 120. The end space 124 may be connected to a lower portion of the body space 123.

The end space 124 is a portion of the stud hole 122. The end space 124 may be a space extending from the lower surface 120b of the stud support 120 toward the upper surface 120a of the stud support 120. The end space 124 may be formed to have a fourth width D4. The fourth width D4 may be larger than the second width D2. The end space 124 may accommodate the end portion 133 of the stud 130 when the stud 130 is inserted into the stud hole 122.

The size D4 of the end space 124 may be larger than the size D5 of the microchip 3, allowing the microchip 3 to be inserted into the end space 124. When the stud support 120 is connected to the sample fixer 110, the microchip 3 mounted on the substrate 1 fixed to the sample fixer 110 may be inserted into a lower portion of the end space 124. Whether the microchip 3 is inserted into the end space 124 may be determined by the length of the end portion 133 of the stud 130, the height of the microchip 3, and other factors. When the height of the microchip 3 is low, a stud 130 with a longer end portion 133 may be used, and the microchip 3 may not be inserted into the end space 124.

An inner surface of the body space 123 may guide the body 132 of the stud 130. During insertion of the stud 130 into the stud hole 122, the inner surface of the body space 123 may guide an outer surface of the body 132. When the body 132 is guided, the end portion 133 may also be aligned with the end space 124.

When the second width D2 is smaller than the size D5 of the microchip 3, and the fourth width D4 is larger than the size D5 of the microchip 3, the end space 124 may not directly guide the end portion 133. Even in such a case, the end portion 133, which is integrally formed at the body 132, may be accurately positioned at the upper surface 3a of the microchip 3 because the body space 123 guides the body 132.

A lower surface 123b of the body space 123 and a lower surface 132b of the body 132 may be formed to be parallel to each other. As the lower surface 132b of the body 132 is seated on the lower surface 123b of the body space 123, the lower surface 133b of the end portion 133 may be positioned parallel to the upper surface 3a of the microchip 3. Accordingly, during the process of fixing the stud 130 and the microchip 3 to each other, tilting does not occur.

During the process of inserting the stud 130 into the stud hole 122, the lower surface 123b of the body space 123 may serve as a stopper limiting the extent to which the stud 130 is inserted into the stud hole 122. The lower surface 123b of the body space 123 is a portion of the stud support 120. When the stud 130 and the stud hole 122 have the form of a straight column, there is a possibility that the stud 130 may collide with the microchip 3 with high force. When the body 132 and the end portion 133 have different sizes, and the body space 123 and the end space 124 correspondingly have different sizes, the stud 130 may only enter the stud hole 122 up to a predetermined distance during insertion thereof.

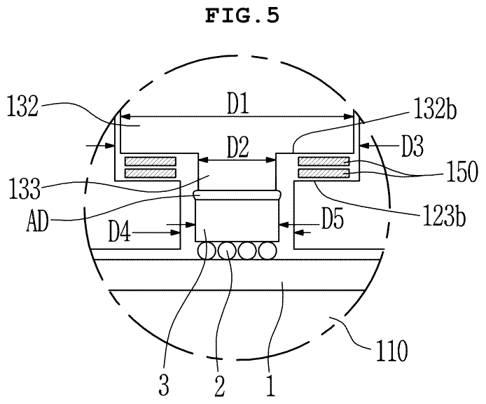

FIG. 5 is a view showing the microchip pull-test jig 11 which uses a distance adjustment ring 150 in accordance with an embodiment.

The microchip pull-test jig 11 may further comprise at least one distance adjustment ring 150 inserted into the body space to adjust an insertion distance of the stud 130, the distance adjustment ring 150 being formed to have an outer size corresponding to the first width D1 and formed with a hole having the second width D2 at a central portion thereof.

The distance adjustment ring 150 is formed to have an outer size corresponding to the first width D1 so that the distance adjustment ring 150 may be inserted into the body space 123. The size of the hole in the distance adjustment ring 150 is slightly larger than the second width D2 so that the end portion 133 may be inserted into the hole. The distance adjustment ring 150 may be formed to have a shape such as a concentric circle, a concentric rectangle, or the like. The distance adjustment ring 150 may be manufactured in various thicknesses. One distance adjustment ring 150 or plural distance adjustment rings 150 may be used.

The distance adjustment ring 150 is inserted into the body space 123 to adjust the insertion distance of the stud 130 into the stud hole 122. As the insertion distance of the stud 130 into the stud hole 122 is adjusted, the position where the end portion 133 contacts the microchip 3 may be adjusted.

For example, when a plurality of distance adjustment rings 150 is used in the case in which the height of the microchip 3 is high, the insertion distance of the stud 130 into the stud hole 122 is reduced, it may be possible to adjust the end portion 133 to be positioned at a level corresponding to the upper surface 3a of the microchip 3 disposed at a high level. Conversely, when a single distance adjustment ring 150 or a small number of distance adjustment rings 150 are used in the case in which the height of the microchip 3 is low, the insertion distance of the stud 130 into the stud hole 122 is increased, it may be possible to adjust the end portion 133 to be positioned at a level corresponding to the upper surface 3a of the microchip 3 disposed at a low level.

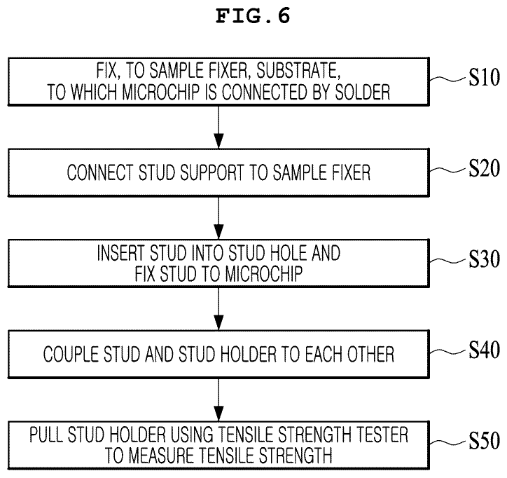

FIG. 6 is a flowchart showing each step of a test method using the microchip pull-test jig 11 in accordance with an embodiment. Refer to FIGS. 3 and 4 together.

The test method using the microchip pull-test jig 11 may comprise sample fixing S10 of fixing a substrate 1, to which a microchip 3 is connected by a solder 2, to the sample fixer 110, support connection S20 of connecting the stud support 120 to the upper portion of the sample fixer 110, chip fixing S30 of inserting the stud 130 into the stud hole 122 of the stud support 120, and fixing the stud 130 to an upper surface of the microchip 3, stud holding S40 of coupling the first coupling portion 131 of the stud 130 to the second coupling portion 141 of the stud holder 140, and measurement S50 of performing tensile strength measurement by controlling, by the controller 13, the tensile strength tester 12 to pull the stud holder 140.

The sample fixing S10 is a step of fixing the substrate 1 to the sample seat 112 of the sample fixer 110. The substrate 1 may be in a state in which the microchip 3 is coupled to the substrate 1 by the solder 2. In the sample fixing S10, the substrate 1 may be fixed to the upper surface 110a of the sample fixer 110 using a clip or the like provided at the sample seat 112.

The holder connection S20 is a step of connecting the stud support 120 to the sample fixer 110. In the holder connection S20, the guide pin 111, which is formed at the edge of the sample fixer 110 to protrude upwards, is inserted into the pin hole 121 formed at the stud support 120. The pin hole 121 of the stud support 120 and the guide pin 111 of the sample fixer 110 are positioned to face each other, and the stud support 120 is then pressed against the upper portion of the sample fixer 110 so that the guide pin 111 may be inserted into the pin hole 121. The guide pin 111 and the pin hole 121 may serve to guide relative positioning of the stud support 120 and the sample fixer 110.

In the holder connection S20, centers of the stud support 120, the sample fixer 110, and the microchip 3 may be aligned along the same line by the guide pin 111 and the pin hole 121. In the holder connection S20, the microchip 3 may be inserted into a lower portion of the guide hole formed at the stud support 120. In the case in which the lower portion of the stud hole 122 is formed to be larger than the microchip 3, the microchip 3 may be inserted into the lower portion of the stud hole 122 of the stud support 120 in the holder connection S20.

The chip fixing S30 is a step of inserting the stud 130 into the stud hole 122, and fixing the stud 130 to the microchip 3. In the chip fixing S30, the lower surface 132b of the body 132 of the stud 130 is supported by the lower surface 123b of the body space 123 such that a predetermined gap is maintained between the upper surface 3a of the microchip 3 and the lower surface 133b of the end portion 133, and the lower surface 133b of the end portion 133 and the upper surface 3a of the microchip 3 are fixed to each other by an adhesive AD. In the chip fixing S30, the adhesive AD may be applied to the upper surface 3a of the microchip 3 before the stud 130 is inserted into the stud hole 122.

Referring to FIG. 5, the test method using the microchip pull-test jig 11 may further comprise insertion distance adjustment of inserting, into the body space 123, at least one distance adjustment ring 150 formed to have an outer size of a first width D1 and formed with a hole with a second width D2 at a central portion thereof, before the chip fixing S30, to adjust an insertion distance of the stud 130.

The insertion distance adjustment is a step of inserting at least one distance adjustment ring 150 into the body space 123. Inserting more rings reduces the insertion distance of the stud 130, whereas inserting fewer rings results in an increase in insertion distance. In accordance with use of the distance adjustment ring 150, it may be possible to perform pull tests on microchips 3 of various heights using a single stud 130 that has a long end portion 133.

The stud holding S40 is a step of holding the first coupling portion 131 of the stud 130 by the second coupling portion 141 of the stud holder 140. The holding method may vary depending on the shapes of the first and second coupling portions 131 and 141. In the stud holding S40, the tensile strength tester 12 may be connected to the upper portion of the stud holder 140.

The measurement S50 may comprise controlling, by the controller 13, the tensile strength tester 12 to pull the stud holder 140, pulling, by the tensile strength tester 12, the stud holder 140 to measure tensile strength and transmitting results of the measurement from the tensile strength tester 12 to the controller 13, and stopping the tensile strength measurement when any one of the microchip 3, the solder 2, and the substrate 1 breaks.

The measurement S50 is a procedure of performing force measurement by pulling the stud holder 140 using the tensile strength tester 12 such that the stud 130 successively pulls the microchip 3. The controller 13 outputs a measurement start command to the tensile strength tester 12. In response to the measurement start command, the tensile strength tester 12 may measure force while pulling the stud holder 140. The tensile strength tester 12 transmits data as to the measured force to the controller 13. The controller 13 may display the measured tensile strength on a display. When any one of the microchip 3, the solder 2, and the substrate 1 breaks, the tensile strength measurement may be stopped.

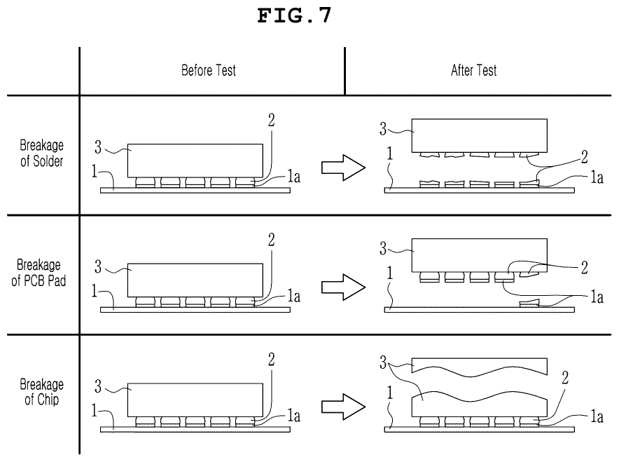

FIG. 7 is a diagram illustrating breakage of the microchip 3, the solder 2, or the substrate 1 according to an embodiment.

When a pull test is performed on the microchip 3 connected to the substrate 1, three possible results may occur. When the solder 2 breaks, this indicates that the pull test was normally conducted. When the microchip 3 breaks, this indicates that the pull test has failed. In this case, the chip may be defective. When the substrate 1 breaks, that is, when a solder pad 1a on the substrate 1 breaks, the pull test also has failed. In this case, the substrate 1 may be defective.

The controller 13 may use only data measured when the solder 2 breaks, as results of the tensile strength measurement. When any one of the microchip 3, the solder 2, and the substrate 1 breaks, the microchip pull-test jig 11 may be disassembled in a reverse order. Then, a pull test may be performed by again executing the above-described procedures, starting from the procedure of fixing the substrate 1 to the sample fixer 110.

As apparent from the above description, using the microchip pull-test jig 11, it may be possible to securely fix the stud 130 to a semiconductor microchip at a correct position and to prevent bonding failure between the semiconductor microchip and the stud 130. Accordingly, it may be possible to reliably perform a pull test of the semiconductor microchip.

The present disclosure has been described in detail through specific embodiments. The above description is only an example applying the principles of the present disclosure, and other configurations may be comprised within the scope of the present disclosure.

What is claimed is:

1. A microchip pull-test jig comprising:
a sample fixer provided, at an upper surface thereof, with a sample seat configured to fix a substrate to which a microchip is connected by a solder;
a stud support disposed over the sample fixer and formed with a stud hole at a position corresponding to the microchip;
a stud fixed to an upper surface of the microchip through the stud hole; and
a stud holder separably coupled to the stud.

2. The microchip pull-text jig according to claim 1, wherein:
the sample fixer further comprises a guide pin protruding upwards from the upper surface of the sample fixer at an edge of the sample fixer around the sample seat; and
the stud support is formed with a pin hole at a position corresponding to the guide pin, allowing insertion of the guide pin into the pin hole.

3. The microchip pull-text jig according to claim 1, further comprising:
an adhesive configured to bond the stud to the microchip.

4. The microchip pull-text jig according to claim 1, wherein the stud comprises:
a body formed to have a first width; and
an end portion formed to have a second width smaller than the first width, the end portion protruding from a lower portion of the body such that the end portion is fixed to the upper surface of the microchip.

5. The microchip pull-text jig according to claim 4, wherein the stud hole comprises:
a body space extending from an upper surface of the stud fixer toward a lower surface of the stud fixer and having the first width; and
an end space formed at a lower surface of the stud support such that the end space is contiguous with a lower portion of the body space and has the second width.

6. The microchip pull-text jig according to claim 5, wherein the end space is formed to have a diameter larger than a size of the microchip such that the microchip is insertable into the end space.

7. The microchip pull-text jig according to claim 5, further comprising:
at least one distance adjustment ring inserted into the body space to adjust an insertion distance of the stud, the distance adjustment ring being formed to have an outer diameter corresponding to the first width and formed with a hole having the second width at a central portion thereof.

8. A test apparatus using a microchip pull-text jig, comprising:
the microchip pull-text jig of claim 1;
a tensile strength tester configured to measure tensile strength by pulling the stud holder; and
a controller configured to receive data of the tensile strength measured by the tensile strength tester and to display the measured tensile strength.

9. A test method using a microchip pull-test jig, comprising:
sample fixing of fixing a substrate, to which a microchip is connected by a solder, to a sample fixer;
support connection of connecting a stud support to an upper portion of the sample fixer;
chip fixing of inserting a stud into a stud hole of the stud support, and fixing the stud to an upper surface of the microchip;
stud holding of coupling a first coupling portion of the stud to a second coupling portion of a stud holder; and
measurement of performing tensile strength measurement by controlling, by a controller, a tensile strength tester to pull the stud holder.

10. The test method according to claim 9, wherein, in the holder connection, a guide pin formed at an edge of the sample fixer to protrude upwards is inserted into a pin hole formed at the stud support.

11. The test method according to claim 9, wherein, in the holder connection, the microchip is inserted into a lower portion of a guide hole formed at the stud support.

12. The test method according to claim 9, wherein:
the stud comprises:
a body formed to have a first width; and
an end portion formed to have a second width smaller than the first width, the end portion protruding from a lower portion of the body such that the end portion is fixed to an upper surface of the microchip;
the stud hole comprises:
a body space extending from an upper surface of the stud support toward a lower surface of the stud support and having the first width; and
an end space formed at the lower surface of the stud support such that the end space is contiguous with a lower portion of the body space and has the second width; and
in the chip fixing, a lower surface of the body of the stud is supported by a lower surface of the body space such that a predetermined gap is maintained between the upper surface of the microchip and a lower surface of the end portion, and the lower surface of the end portion and the upper surface of the microchip are fixed to each other by an adhesive.

13. The test method according to claim 12, further comprising:
insertion distance adjustment of inserting, into the body space, at least one distance adjustment ring formed to have an outer diameter of a first width and formed with a hole having a second width at a central portion thereof, before the chip fixing, to adjust an insertion distance of the stud.

14. The test method according to claim 9, wherein the measurement comprises:
controlling, by the controller, the tensile strength tester to pull the stud holder;
pulling, by the tensile strength tester, the stud holder to measure tensile strength and transmitting results of the measurement from the tensile strength tester to the controller; and
stopping the tensile strength measurement when any one of the microchip, the solder, and the substrate breaks.
